(19) United States
(12) Patent Application Publication
(10) Pub. No.: US 2007/0063995 A1
(43) Pub. Date: Mar. 22, 2007

(54) Graphical user interface for use with a multi-media system

(76) Inventors: Eric A. Bailey, Kokomo, IN (US); Mona L. Toms, Carmel, IN (US); Victor V. Chernetsky, Kokomo, IN (US)

Correspondence Address: DELPHI TECHNOLOGIES, INC., M/C 480-410-202, PO BOX 5052, TROY, MI, 48007, US

(21) Appl. No.: 11/232,510

(22) Filed: Sep. 22, 2005

(51) Int. Cl. G09G 5/00

(52) U.S. Cl. 345/184

(57) ABSTRACT

A graphical user interface for use with a multi-media system, such as those found in vehicles, that includes a rotary knob, a graphics control circuit and a graphics display with a graphical depiction of a portion of the rotary knob. The graphical depiction includes a menu wheel and at least two menu items located near its periphery, where each of the menu items corresponds with a device, system or network (i.e.—satellite radio, navigation system, DVD player, video game system, wireless internet, etc.) with which the multi-media system can interact. Furthermore, rotation of the rotary knob by a user causes a corresponding graphical movement of the menu items along a periphery of the menu wheel.

### TECHNICAL FIELD

The present invention generally relates to a graphical user interface, and more particularly, to a graphical user interface having a rotary knob and a graphics display and being used with a multi-media system such as those found on vehicles.

### BACKGROUND OF THE INVENTION

Traditional consumer electronics found on a vehicle usually only included a radio, but now oftentimes include a wide variety of electronic devices such as traditional and satellite radios, navigation systems, CD players, DVD players, MP3 players, traditional and satellite televisions, video game systems, wireless internet and local area networks, and connections for interaction with auxiliary devices such as personal PDAs, hard drives, etc., to name but a few. Furthermore, each of these electronic devices is typically accompanied by a fairly lengthy set of features and options, thus increasing the overall complexity of the corresponding menu options and controls.

With all of these electronic devices available, it is desirable that the human-to-machine interface be as enjoyable and easy to use as possible, otherwise the user may find that they are unable to effectively navigate the interface due to cluttered screens, incomprehensible icons, small lettering, or unintuitive menu structures. Instead of creating an enjoyable experience, a complex, non-intuitive and confusing interface can cause a user to become frustrated with their inability to easily accomplish what should be a relatively simple task.

### SUMMARY OF THE INVENTION

According to one aspect of the present invention, there is provided a graphical user interface for use with a multi-media system that includes a rotary knob, a graphics control circuit and a graphics display with a graphical depiction of at least a portion of the rotary knob. The graphical depiction includes a menu wheel and at least two menu items, wherein rotation of the rotary knob causes a corresponding arcuate movement of the menu items along the periphery of the menu wheel.

According to another aspect, there is provided a method for operating a vehicle multi-media system which includes: providing a graphical user interface having a rotary knob, a graphics control circuit and a graphics display with a graphical depiction having a menu wheel and at least two menu items; generating an electronic position signal; generating an electronic graphics signal; and graphically moving the menu items along an arcuate periphery of the menu wheel so that the graphical movement generally corresponds to the actual rotation of the rotary knob.

Objects, features and advantages of this invention include, but are certainly not limited to, providing a graphical user interface that is intuitive and makes the selection and control of a multi-media system, such as those found in a vehicle, as enjoyable and simple to use as possible.

### BRIEF DESCRIPTION OF THE DRAWINGS

These and other objects, features and advantages of this invention will be apparent from the following detailed description of preferred embodiments and best mode, the appended claims and the accompanying drawings, in which:

FIG. 1 is a block diagram of an example of a vehicle multi-media system; and

FIG. 2 is a front view of an embodiment of a graphical user interface that can be used with the vehicle multi-media system of FIG. 1.

### DETAILED DESCRIPTION OF THE INVENTION

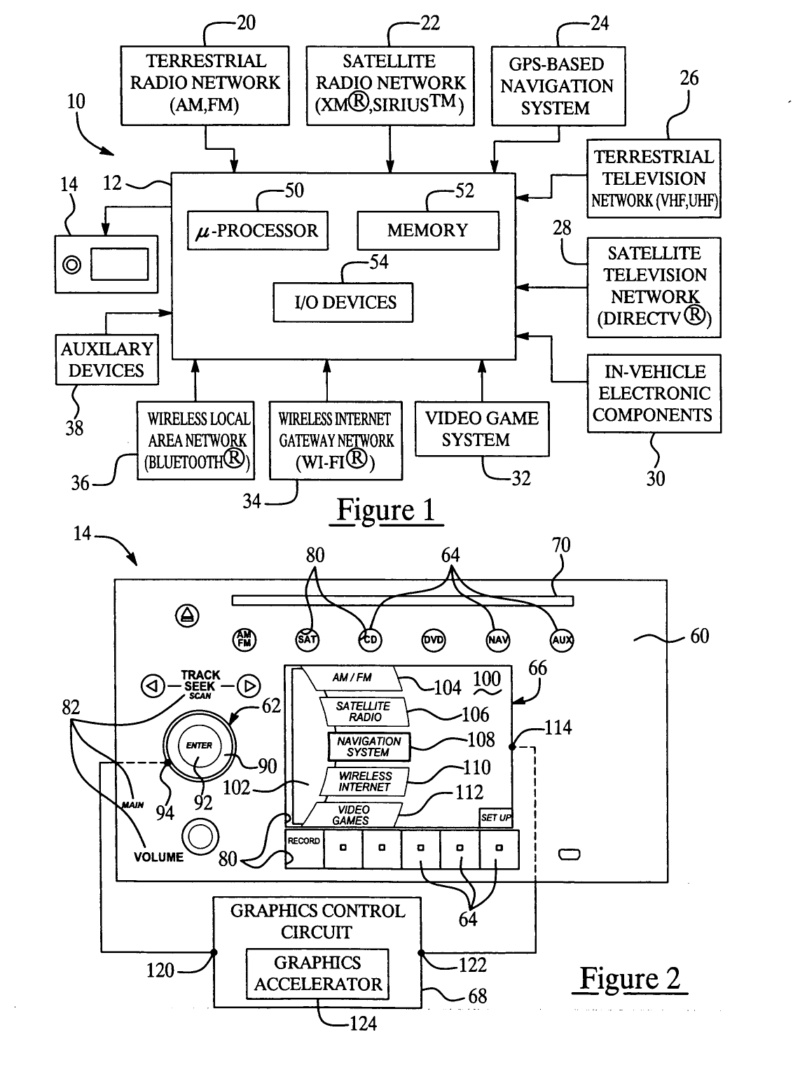

Numerous examples of vehicle multi-media systems are known and used in the art, including the embodiment shown in FIG. 1. Multi-media system 10 brings together a wide variety of electronic devices, systems and networks to provide vehicle occupants with an integrated and enjoyable entertainment and informative experience. Although system 10 is an example of a multi-media system that can utilize the graphical user interface of the present invention, the graphical user interface of the present invention can also be used with a wide variety of other multi-media systems, not just the one shown in FIG. 1. According to the particular embodiment shown here, multi-media system 10 generally includes a system control circuit 12 and a graphical user interface 14, and interacts with a variety of electronic devices, systems and networks 20-38.

System control circuit 12 functions as the primary hub or processing unit for multi-media system 10 and is able to communicate with the various devices, systems and networks 20-38. Some of these devices, systems and networks are entirely located on the vehicle (CD, DVD and MP3 players, etc.), while others require external interaction (GPS navigation, satellite television and satellite radio systems, etc.). According to a preferred embodiment, system control circuit 12 includes a microprocessor 50 for executing instructions, one or more electronic memory devices 52 for saving instructions, several I/O devices 54 acting as receivers, transmitters and/or transceivers, as well as numerous other electronic components known to those skilled in the art. For a more detailed explanation of a multi-media system control circuit, please see U.S. Pat. No. 6,529,804 assigned to Motorola, Inc. of Schaumburg, Ill.

As previously mentioned, system control circuit 12 interacts with a wide variety of internal and external electronic devices, systems and networks in order to provide the vehicle occupants with a variety of entertainment and information providing options. According to this particular embodiment, multi-media system 10 interacts with the following electronic devices, systems and networks: a terrestrial radio network 20 (AM, FM), a satellite radio network 22 (XM®, SIRIUS™), a GPS-based navigation system 24, a terrestrial television network 26 (VHF, UHF), a satellite television network 28 (DIRECTV®), vehicle mounted electronic components 30 (CD, DVD, MP3 players), a video game system 32, a wireless internet gateway network (WI-FI®) 34, a wireless local area network (BLUETOOTH®) 36, and auxiliary devices 38 such as personal PDAs, hard drives, cellular phones, etc., to name but a few. Of course, multi-media system 10 could interact with a different combination of electronic devices, systems and networks than those shown, as examples 20-38 are simply provided for purposes of illustration.

Turning now to FIG. 2, there is shown an embodiment of graphical user interface 14 which provides an appealing and intuitive interface for controlling a multi-media device, such as the one previously described in conjunction with FIG. 1. Graphical user interface 14 preferably includes a face plate 60, a rotary knob 62, various buttons 64, a graphics display 66 and a graphics control circuit 68, a CD load/unload slot 70, and enables a user to easily navigate through a variety of menus and options.

Face plate 60 is preferably made from a durable plastic material and acts as a protective housing component for graphical user interface 14. According to the embodiment shown here, face plate 60 includes numerous cutouts 80 for accommodating features of the graphical user interface and indicia 82 for conveying information to the user. Cutouts 80 pass completely through face plate 60 and are shaped and sized to accommodate various components, including rotary knob 62, buttons 64, graphics display 66, as well as other ports, slots and features such as a CD load/unload slot 70. Indicia 82 can either be illuminated or non-illuminated and provides the user with information as to the purpose of each of the knobs, buttons, controls, ports, slots, features, etc.

Rotary knob 62 is used in conjunction with graphics display 66 and provides the user with a familiar and an easy to use control for scrolling through a variety of menus and options. According to a preferred embodiment, rotary knob 62 is a generally cylindrical component having an outer rotating portion 90, a center button 92 and a signal output 94 for providing the graphics control circuit 68 with several electronic signals. Although a number of different rotary knob types and designs and could be used with the graphical user interface, the following models are especially applicable: 09400315 Control-ABC, HS, 30D and 09400316 Control-ABC, HS, 18D both sold by Matsushita Electric Industrial Co. Ltd., EVQ-BUC-039-09B and EVQ-BU4-039-15B both sold by Tsuyama Matsush, and EC11E15244E8 and EC11E09244 both sold by Alps Electric.

Outer rotating portion 90 circumferentially surrounds center button 92 and provides the user with a surface for grasping and turning the rotary knob. The outer rotating portion can be provided with serrations, ridges or other surface features to facilitate easy grasping of the knob, or it can simply have a smooth outer surface. Preferably, the outer rotating portion, and hence rotary knob 62, have a number of rotational detent positions that each correspond to a different menu item. These detent positions, which can be either mechanical or electrical detents, enable a user to easily scroll through a series of menu items and know when one is locked into a selectable position, as will be subsequently explained in greater detail. Outer rotating portion 90 can include an integral rotational position sensor for generating an electronic position signal representative of the rotational position of the rotary knob. Preferably, the rotational position sensor is a 3-wire encoder type such as those known in the art, but it could alternatively be a separate, non-integral sensor that is in operable communication with rotating outer portion 90. It should be noted, the ‘electronic position signal’ broadly includes not only those signals which provide information as to the actual or absolute rotational position of the knob, but also those signals which simply indicate that the knob is being turned in a particular direction.

Center button 92 is generally concentric with outer rotating portion 90 and allows the user to make a selection that is communicated to graphics control circuit 68 via an electronic selection signal. Center button 92 can either be the type of button that remains stationary as outer rotating portion 90 is being turned, or it can be more unitary in that it rotates with the outer rotating portion. The electronic selection signal generally pertains to the operational state of center button 92 and informs graphics control circuit 68 when the user makes a selection by depressing or otherwise engaging the center button.

Signal output 94 generally provides data signals from rotary knob 62 to graphics control circuit 68, and broadly includes any type of signal output that can reasonably be used in a graphical user interface of the type shown here. For instance, three separate signals could be provided on the same wire; a first signal indicating a clockwise turning of rotary knob 62, a second signal indicating a counterclockwise turning of the knob, and a third signal indicating a depression of center button 92. Moreover, the connection between rotary knob 62 and graphics control circuit 68 is preferably hard-wired, however, it could use a short range wireless link (BLUETOOTH®) instead. In any event, signal output 94 provides one or more signals to graphics control circuit 68 which generally indicate the position and/or operational state of rotary knob 62.

Buttons 64, as well as other user controls and features located on graphical user interface 14, can simply be standard radio or multi-media system controls, as are known in the art. It is of course possible to provide a graphical user interface that is operated exclusively by a rotary knob, and thus does not require additional buttons 64.

Graphics display 66 provides a graphical depiction of a portion of rotary knob 62 that generally includes a menu wheel 102 and menu items 104-112, such that actual rotation of the rotary knob by a user causes a corresponding arcuate movement of the menu items along a periphery of the menu wheel. Graphics display 66 can be provided according to a number of different technologies, but is preferably a touch-screen type display that includes an LCD 100 and a signal input 114. Examples of appropriate graphics displays are sold by Sharp Corp. and include some of their 6.5″ models. With the touch-screen, the user is given the ability to make a selection either with center button 92, as previously explained, or by simply selecting the desired menu item on LCD 100 directly. As with signal output 94, signal input 114 can be provided according to one of a number of different embodiments, but preferably provides graphics display 66 with an electronic graphics signal that is used in developing the graphical depictions discussed below.

Menu wheel 102 is preferably an arcuate graphical element that extends from the top of LCD 100 to the bottom, and generally represents an enlarged outer portion of rotary knob 62. In the particular embodiment shown here, menu wheel 102 graphically represents an enlarged portion of rotary knob 62 extending for approximately 20°-40° around the outer circumference of the rotary knob. Of course, alternative menu wheel configurations could be used instead, such as those having a straight vertical line, for example. In order to further enhance the similarity and correspondence between the actual rotary knob 62 and the graphical menu wheel 102, both items could be given the same color and/or surface texture.

Menu items 104-112 each represent a different content source and are located along a section of the periphery of menu wheel 102. A “content source” broadly includes any device, system or network that provides content to be used by multi-media system 10; this includes, but is certainly not limited to, the various electronic devices, systems and networks 20-38 that were previously discussed. According to the particular embodiment shown here, each menu item 104-112 is represented by a closed figure (colored, shaded, blank, etc.) that surrounds indicia indicating the identity of a corresponding content source, and that has a pair of straight horizontal lines connected to a pair of curved generally vertical arcs. For instance, menu item 104 is represented by shaded, closed figure surrounding indicia bearing the letters “FM”, thus indicating that it corresponds to an FM radio content source. This is, of course, only one example of a menu item, as numerous other menu item embodiments could alternatively be used.

The number of menu items displayed on graphics display 66 is dependent on a variety of factors, including the size specifications for the LCD and the font (the larger the screen size or the smaller the font size, the greater the number of menu items) and the options package selected on that particular vehicle, to name but a few. Menu wheel 102 is a revolving menu wheel so that graphics display 66 can handle a large number of menu items; not just those menu items 104-112 currently shown on the screen. For example, if the multi-media system 10 is designed to communicate with eight different content sources but only five menu items 104-112 fit on graphics display 66 at any one time, then three menu items would be hidden (off-screen) until the user turns rotary knob 62. When the rotary knob is turned, a previously displayed menu item 104-112 is rotated off of menu wheel 102 and becomes hidden, and a previously hidden menu item is rotated on the menu wheel so that it is displayed. Preferably, graphics display 66 moves the various menu items in an animated manner so that they appear to continuously move between adjacent positions along the arcuate periphery of menu wheel 102, as will be explained in greater detail.

Graphics control circuit 68 generally controls graphics display 66, and can be part of a larger overall control circuit (such as system control circuit 12) or it can be a relatively-independent circuit that may interact with system control circuit 12 but is located remotely from it. According to a preferred embodiment, graphics control 68 generally includes an input 120 for receiving an electronic position signal from rotary knob 62, an output 122 for providing an electronic graphics signal to graphics display 66, a graphics accelerator 124, as well as other electronic components known to those skilled in the art. One example of an appropriate graphics control circuit is the Hitachi SH4 CPU, particularly Model No. 7750. In this particular embodiment, the CPU generally controls a graphics accelerator, which in turn generally controls the graphics display.

Graphics accelerator 124 improves the speed and quality of the animation or movement of menu items 104-112, and can be one of a number of appropriate models, including the Hitachi Q2SD and Q2SE each of which are 2-dimensional graphics accelerators. Again, this description is only of a general, preferred graphics control circuit 68, as alternative circuits having additional components will be appreciated by those skilled in the art and could be used.

In operation, graphical user interface 14 provides a user of multi-media system 10 with an appealing and intuitive interface for scrolling through a variety of menus and options. Clockwise and counterclockwise rotations of rotary knob 62 have the same general effect on graphics display 66, besides the direction of movement of the graphics. Thus, the following description of a clockwise rotation of rotary knob 62 generally applies to a counterclockwise rotation as well.

Beginning with the graphics display 66 shown in FIG. 2, a sufficient clockwise rotation of rotary knob 62 causes each of the menu items 104-112 to move downwards to an adjacent menu item position, so that the actual rotation of the rotary knob is simulated by a graphical rotation of the menu items about the menu wheel. First, when the user turns rotary knob 62, it causes the rotational position sensor to generate an electronic position signal that is generally representative of the rotational position and/or status of the rotary knob. This signal is sent from rotary knob 62 to graphics control circuit 68 via signal output 94 and input 120. Reception of the electronic position signal causes graphics control circuit 68, and more specifically graphics accelerator 124, to generate an electronic graphics signal that is generally representative of the position signal. This graphics signal, in turn, is sent to graphics display 66 via signal output 122 and input 114, and causes a graphical movement of the menu items along a portion of the menu wheel periphery that generally corresponds to the actual rotation of the rotary knob by the user.

In the event that all of the content sources, and hence menu items, available for a particular multi-media system can be represented on menu wheel 102 at the same time, then clockwise rotation of rotary knob 62 causes each of the menu items 104-110 to move one position downwards and menu item 112 to be rotated to the top of the list. For example, menu item 104 assumes the place of item 106, 106 assumes the place of 108, 108 assumes the place of 110, 110 assumes the place of 112, and 112 assumes the place of 104. In the case where the total number of menu items exceeds the number that can be displayed at any one time, then clockwise rotation of the rotary knob causes an off-screen menu item that is next in line to move into the top menu item 104 position, and causes the bottom menu item 112 to move into an off-screen position so that it is hidden from the user. In this example, an off-screen, previously hidden menu item is displayed in place of item 104, item 104 assumes the place of item 106, 106 assumes the place of 108, 108 assumes the place of 110, 110 assumes the place of 112, and 112 is rotated to a hidden, off-screen position.

The optional detent positions of rotary knob 62 each corresponds to a different menu item position, so that actual rotational movement between the discrete detent positions is felt by the user and is simulated by the graphical depiction of the menu items 104-112 moving along the arcuate periphery of menu wheel 102. These discrete detent positions provide the user with an intuitive awareness of when a menu item is locked into a particular menu item position.

According to a preferred embodiment, graphics display 66 rotates the various menu items 104-112 in an animated matter so that they appear to move continuously between adjacent menu item positions. This continuous animated movement is appealing to the user in that it provides a more realistic simulation of the actual movement of rotary knob 62. Graphics display 66 maps quite well to the actual clockwise or counterclockwise movement of the rotary knob, and the continuous animation can be used with either the detent or smooth, non-detent embodiments.

The menu item located in the middle position of graphics display 66 (menu item 108 in FIG. 2) is the selectable menu item and the user can select it by simply depressing center button 92 or by touching it on the touch-screen. The selectable menu item is generally identified by some means such as a different font color, a different font size, bold font, italicized font, a box around the selectable menu item, etc. Once the user has adjusted rotary knob 62 such that the desired menu item, and hence content source, is rotated into the selectable menu item position, engagement of center button 92 causes output 94 to send an electronic selection signal to graphics control circuit 68, which in turn conveys that information to graphics display 66.

Of course, other means for selecting the desired content source could be used as well. Once a particular menu item is selected, graphics display 66 displays the next lower level menu for the particular content source that was selected so that the user can engage and operate that content source. For instance, if navigation system 24 (menu item 108) were selected, then a navigation system-specific menu would be displayed so that the user can begin using that content source.

It will thus be apparent that there has been provided in accordance with this invention a graphical user interface for use with a multi-media system which achieves the aims and advantages specified herein. It will, of course, be understood that the forgoing description is of preferred exemplary embodiments of the invention and that the invention is not limited to the specific embodiments shown.

For example, instead of providing rotary knob 62 with detent positions, the knob could be provided to allow for continuous, smooth rotation without discrete detent positions. Furthermore, graphical user interface 14 is described above in the context of a vehicle multi-media system, however, it could just as easily be utilized with numerous other multi-media systems including non-vehicle systems such as a home, boat or portable multi-media system. Various changes and modifications will become apparent to those skilled in the art and all such changes and modifications are intended to be within the scope of this invention.

I claim:

1. A graphical user interface for use with a multi-media system, comprising:
a rotary knob having an output for providing a position signal generally representative of the rotational position of the rotary knob;
a graphics control circuit having an input coupled to the rotary knob output for receiving the position signal and having an output for providing a graphics signal generally representative of the position signal; and
a graphics display having an input coupled to the graphics control circuit output for receiving the graphics signal and having a graphical depiction of at least a portion of the rotary knob, the graphical depiction including a menu wheel and at least two menu items located near a periphery of the menu wheel, wherein rotation of the rotary knob causes a corresponding arcuate movement of the menu items along the periphery of the menu wheel.

2. The graphical user interface of claim 1, wherein the rotary knob further includes an outer rotating portion and a center button, the position signal generally pertains to the rotational position of the outer rotating portion and a selection signal generally pertains to the state of the center button.

3. The graphical user interface of claim 1, wherein the rotary knob has a plurality of rotational detent positions that each correspond to one of the menu items.

4. The graphical user interface of claim 1, wherein the graphics display includes a touch-screen LCD.

5. The graphical user interface of claim 1, wherein the menu wheel is a graphical depiction of an enlarged outer portion of the rotary knob.

6. The graphical user interface of claim 1, wherein the menu items are represented by closed figures surrounding indicia that indicates the identity of a corresponding content source.

7. The graphical user interface of claim 1, wherein the menu wheel is a revolving menu wheel so that if the number of the menu items exceeds the space available on the graphics display, then rotation of the rotary knob causes a previously displayed menu item to become hidden, and a previously hidden menu item to become displayed.

8. The graphical user interface of claim 1, wherein the graphics display rotates the menu items around the menu wheel in an animated manner so that they appear to move continuously between adjacent positions.

9. The graphical user interface of claim 8, wherein the graphics control circuit includes a graphics accelerator for aiding in the animation.

10. The graphical user interface of claim 1, wherein the graphical user interface is used with a vehicle multi-media system that interacts with at least three of the following content sources: a terrestrial radio network, a satellite radio network, a navigation system, a terrestrial television network, a satellite television network, a vehicle mounted electronic component, a video game system, a wireless internet gateway network and a wireless local area network.

11. A method for operating a vehicle multi-media system, comprising the steps of:
(a) providing a graphical user interface having a rotary knob, a graphics control circuit and a graphics display that includes a graphical depiction of at least a portion of the rotary knob, the graphical depiction includes a menu wheel and at least two menu items located near a periphery of the menu wheel;
(b) generating an electronic position signal in response to rotation of the rotary knob;
(c) generating an electronic graphics signal in response to receiving the electronic position signal, and;
(d) graphically moving the menu items along an arcuate periphery of the menu wheel, wherein the graphical movement of the menu items generally corresponds to the actual rotation of the rotary knob.
